(19) United States
(12) Patent Application Publication
(10) Pub. No.: US 2019/0003586 A1
(43) Pub. Date: Jan. 3, 2019

(54) METHOD FOR LEARNING THE NEUTRAL POSITION OF A GEAR SHIFT ACTUATOR

(71) Applicant: Nissan Motor Co., Ltd., Yokohama-shi Kanagawa (JP)

(72) Inventors: Ludovic MERIENNE, Gif Sur Yvette (FR); Ahmed KETFI-CHERIF, Elancourt (FR)

(21) Appl. No.: 15/748,681

(22) PCT Filed: Sep. 5, 2016
(86) PCT No.: PCT/FR2016/052188

§ 371 Date: Jan. 30, 2018

(30) Foreign Application Priority Data
Sep. 10, 2015 (FR) 1558446

(51) Int. Cl. F16H 61/28; F16H 61/32; F16D 11/14; F16D 21/00; F16H 63/30; F16H 63/10; F16D 48/06

(52) U.S. Cl. CPC F16H 61/28; F16H 61/32; F16D 11/14; F16H 2061/0087; F16H 63/304; F16H 63/10; F16D 48/064; F16D 21/00

(57) ABSTRACT

A method is provided for learning a neutral position of a gear shift actuator with a sliding gear movable between two opposed engaging pinions. The gear shift actuator has a control element that is position-regulated by a drive motor to acts on the slide gear. The slide gear has a spring that accumulates energy when the teeth of the sliding gear abut against the pinion to shift the gears and then restore this energy by relaxing to assist the engagement of the teeth of the sliding gear between the pinion. The method determines the neutral position of the actuator by identifying the positions of the control element at a time when the teeth of the sliding gear abut against the teeth of each of the two pinions by observing a resistant torque on the control element during movement of the sliding gear towards the pinions.

### CROSS-REFERENCE TO RELATED APPLICATIONS

This application is a U.S. National stage application of International Application No. PCT/FR2016/052188, filed on Sep. 5, 2016, which claims priority to French Patent Application No. 1,558,446, filed on Sep. 10, 2015.

### BACKGROUND

### Field of the Invention

The present invention relates to the command of a gear shift actuator, for a robotized transmission.

### SUMMARY

More precisely, the object of the invention is a method for learning the neutral position of a gear shift actuator having a motorized sliding gear between two opposite engaging pinions, including a command element that is position-controlled by the drive motor thereof, which acts on a mechanical assembly for moving the sliding gear provided with an assistance system having a spring which can firstly accumulate energy when the teeth of the sliding gear come into abutment against those of the pinion to be dog-coupled in order to shift gear, and secondly restore this energy by expansion, in order to assist the engagement of the teeth of the sliding gear between those of this pinion.

Some combustion engine or hybrid power trains have transmissions with dogs, the ratios of which are engaged by couplers having flat teeth, or dogs, without mechanical synchronizers. These transmissions are generally “robotized”, i.e. the operation thereof is that of a manual transmission, but the gear shifting is automated.

FR3012861 discloses a shock-absorbing gear shift actuator for a motorized-sliding gear dog transmission, and the control method thereof. The actuator includes a motorized command element (or actuating finger), a mechanical assistance system having a spring which can firstly accumulate energy when the teeth (or dogs) of a sliding gear come into abutment against those of the pinion to be dog-coupled in order to shift gear, and secondly restore this energy by expansion, in order to assist the engagement of the teeth. The assistance principle consists in compressing a spring which stores the energy provided by the actuator when the teeth of the sliding gear and of the pinion are in abutment, and in releasing this energy when the dog coupling is possible, by accelerating the fork. The acceleration obtained depends on the compression of the spring, and therefore on the torque transmitted by the electric motor during the step where the teeth are in abutment. The proposed control is based on the detection of the abutment of the sliding gear against the pinion in such a way as to limit the torque applied to the command element.

An important step after mounting the shift actuator consists in learning the position of the mechanical neutral, i.e. the central position of rest of the sliding gear between the two pinions, when no ratio is engaged. The aim of this learning is that the actuator can receive during operation the correct positional set point in order to center the neutral. Due to the numerous mounting clearances, the position of the neutral can vary greatly from one piece to another. It is therefore not possible to ensure that the neutral is actually on the set point selected without prior learning of the neutral position.

Given that the actuating motor has position control, which enables the movements of the command element to be governed, the invention provides for identifying the characteristic positions of the command element of the actuator from the position measurements thereof, and from the current flowing in the actuating motor.

To this end, it proposes determining the neutral position of the actuator by identifying the positions of the command element when the teeth of the sliding gear abut against those of each of the two pinions, by observing the resisting torque on the command element during the movement of the sliding gear towards the pinions.

Preferably, the method includes a first step of calculating the distance between the abutment positions by detecting the positions of the command element, when the value of the resisting torque estimated thereon crosses a threshold indicating the abutment of the sliding gear.

This first step may be followed by a second step of finer measurement of the abutment positions of the sliding gear, consisting in placing the command element in an identified abutment position, then releasing it by cutting off the actuating motor, to ensure that it retains this position.

The proposed method uses observation techniques to estimate a resisting force on the command element, in order to identify the compression of the spring. It includes a sequence of actions making it possible to obtain a very precise estimation of the abutment positions.

Other features and advantages of the invention will emerge clearly upon reading the following description of a non-limiting embodiment thereof, with reference to the appended drawings, in which:

### BRIEF DESCRIPTION OF THE DRAWINGS

FIG. 1 is a schematic diagram of the actuator in question,

FIG. 2 summarizes the first step of the method,

FIG. 3 is an algorithm for estimating the resisting torque,

FIG. 4 illustrates a first step of the method, with locking of the teeth of the sliding gear on those of the pinion,

FIG. 5 illustrates a second step of the method, without locking of the teeth of the sliding gear on those of the pinion,

FIG. 6 illustrates a second step of the method, and

FIG. 7 illustrates a case of making the latter fail.

### DETAILED DESCRIPTION OF EMBODIMENTS

Selected embodiments will now be explained with reference to the drawings. It will be apparent to those skilled in the field from this disclosure that the following descriptions of the embodiments are provided for illustration only and not for the purpose of limiting the invention as defined by the appended claims and their equivalents.

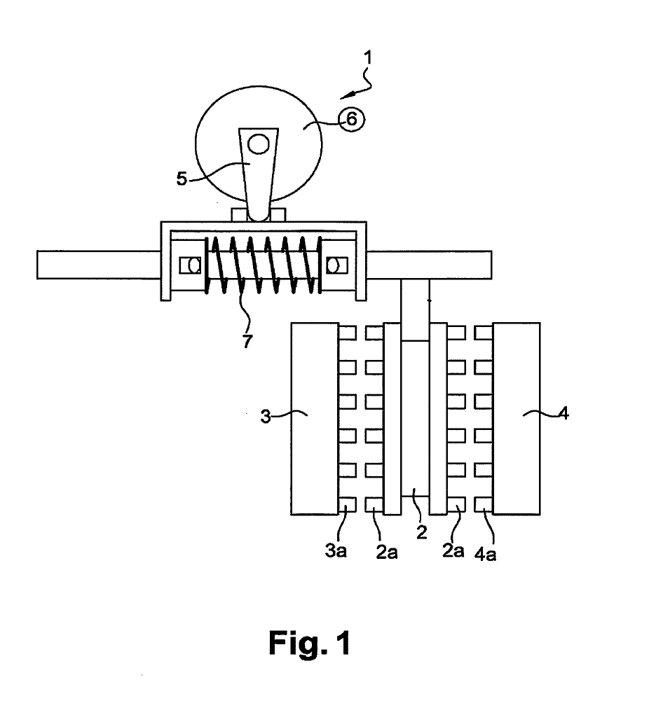

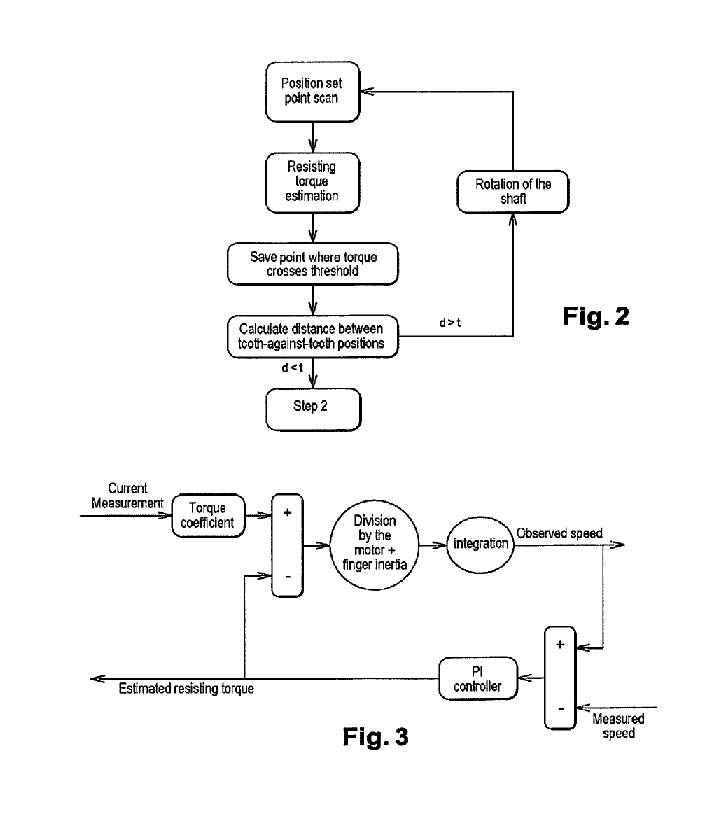

The method which is the object of the invention is illustrated in FIGS. 2 to 7. It makes it possible to learn the neutral position of a gear shift actuator 1 having a motorized sliding gear 2, such as that of FIG. 1, between two opposite engagement pinions 3, 4. The actuator 1 includes a command element 5, such as an actuating finger, or another system. The command element 5 is position-controlled by the drive motor 6 thereof. It acts on a mechanical assembly for moving the sliding gear comprising an assistance system having a spring 7, which can accumulate energy when the teeth of the sliding gear 2a come into abutment against those of a pinion 3a, 4a in order to shift a gear. The spring 7 subsequently restores this energy by expansion in order to assist the engagement of the teeth of the sliding gear between those of this pinion.

The method of the invention mainly comprises two steps:

a first step, called a “position scan” with recording of the resisting force; the distance between the positions for locking teeth, called abutment, is calculated by detecting the positions of the command element when the value of the resisting torque estimated thereon crosses a threshold indicating the abutment of the sliding gear;

a second step of adjustment about the identified positions of abutment, in order to obtain the required accuracy on these positions.

The end of the second stage produces the two positions of abutment of the teeth of the sliding gear against those of the pinions, with sufficient accuracy to deduce therefrom the position of the mechanical neutral between them.

The first step is summarized in FIG. 2. It consists in scanning at least once the positions of the command element by estimating the resisting force thereof along the travel thereof, in defining a force threshold, and in saving on the travel of the command element the positions where this threshold is crossed. Firstly, the command element is thus made to cover the entire travel permitted. The values of the resisting torque on the command element are regularly recorded, for example every 0.2 mm. For this purpose, the command element 5 can be driven by a speed set point or by a ramp position set point, i.e. which scans all of the reachable positions in a linear manner.

The estimation of the resisting torque on the command element takes place preferably via a so-called “observation” method, according to FIG. 3. It is based on the observation of the speed of the drive motor using a measurement of the current thereof, and on the measurement of this speed. The resisting torque is estimated in a controller, using the difference between the observed speed and the measured speed of the actuating motor 6. The observed speed is obtained by integrating a term representing the difference between a theoretical torque resulting from the current measurement modified by a torque coefficient, and from the value of the estimated torque.

The advantage of the observation method, on torque direct calculations, is the great robustness thereof with respect to the measurement noise, and large dynamics. It does not comprise any derivative calculation (which have the disadvantage of amplifying the noise) but only integration calculations, which filter the noise. The PI (Proportional Integral) controller makes it possible to converge the observed speed towards the measured speed, and the parameterization thereof makes it possible to promote the dynamics of the estimation, or the accuracy thereof. Accuracy is sought in order to be able to distinguish very small deviations on the resisting torque of the command element.

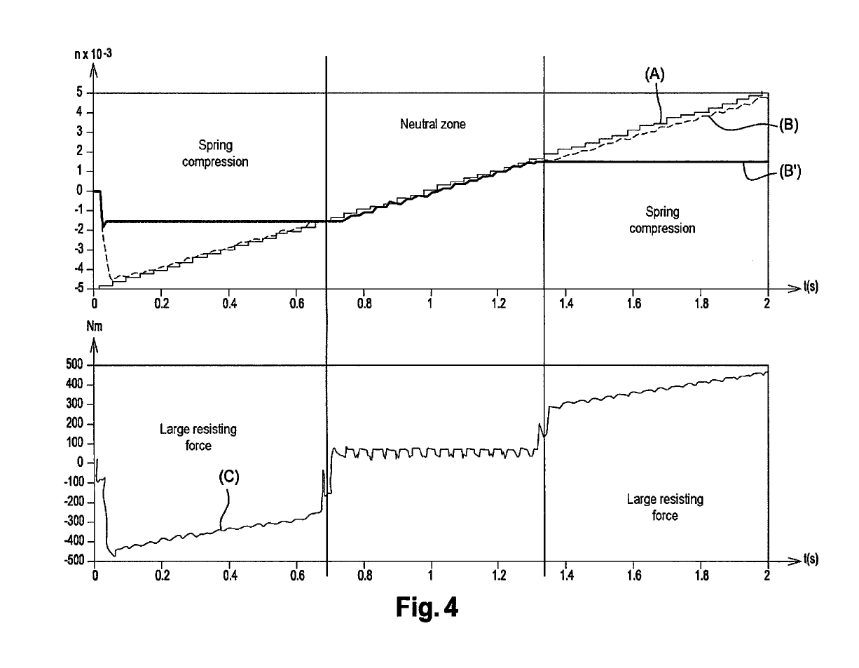

In 90% of cases, the teeth of the sliding gear come into abutment against those of the pinion. The graphs of FIG. 4 illustrate this situation. The curve (A) reproduces the position set point of the finger, and the curve (B) the measured position of the finger. In order to highlight the tooth-against-tooth locking, the position of the fork actuated by the sliding gear has been added indicatively as (B′), although this position is not normally detectable on the actuator. Finally, the curve (C) shows the value of the estimated resisting torque. In this example, the forces were recorded every 0.2 mm. The spring compression begins just before the position −1.8 mm on one side and 1.6 mm on the other. The neutral space is approximately 3.4 mm. The accuracy is not sufficient, but the second calculating step is intended to refine it.

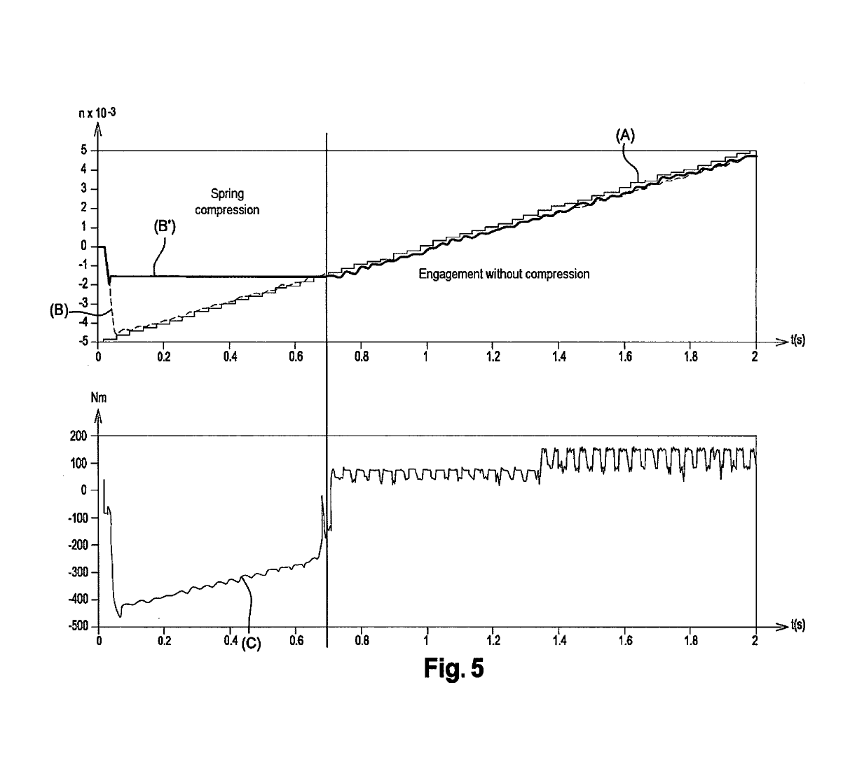

FIG. 5 refers to the scan tests (approximately 10% of cases), where the alignment of the teeth is good. The dogs 2a of the sliding gear engage directly between those of a pinion. The resisting torque does not increase over the entire travel. Since the teeth lock in 90% of cases, it is pointless to try to adjust the angle of the shaft to avoid the abutments of the teeth. The rotation thereof makes it possible to undertake a new attempt by repeating the first step if the teeth of the sliding gear 2a engage directly between those of a pinion 3a, 4a at the end of travel. These attempts quickly become successful. Indeed, after five scans, the teeth 2a of the sliding gear did not abut against those of the pinion, in only 0.001% of cases.

When scanning the positions, the resisting torque on the command element is recorded as an absolute value. A force threshold is defined beyond which it is certain that the finger is no longer entirely free, that is to say that the assist spring is compressed. It is, for example, approximately 200 Nm. The distance (d) between the two positions where the resisting torque remains below the threshold is calculated and compared with the actual difference (e) therebetween. If the distance is greater than the difference (d>e), the teeth of the sliding gear have not abutted against those of the pinion. The transmission shaft in question is rotated, for example by sending a torque request to a drive motor of the vehicle in order to rotate the sliding gear. The scan is repeated until d<e. The end of the first step produces a first estimate of the abutment positions.

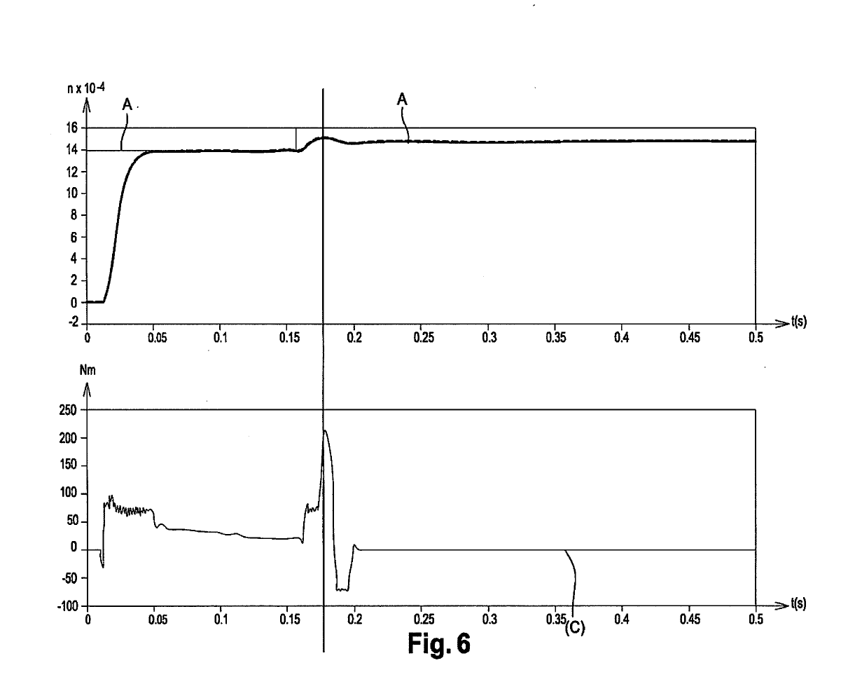

It is possible to proceed to the second step which provides a finer measurement of the abutment positions of the sliding gear. It consists in placing the command element in an abutment position identified in step one, then in releasing it by cutting off the actuating motor to ensure that it retains this position. For this purpose, the command element is brought into the already calculated position for locking the teeth. The command element is then let go by cutting off the actuating motor. The spring pushes back the finger, or not, depending on whether it is compressed or not. If the locking position is known from the first step to within 0.2 mm, the command element remains at the locking level after the motor has been cut off, with an accuracy of approximately 0.03 mm relative to the abutment actual position. This is the case in FIG. 6.

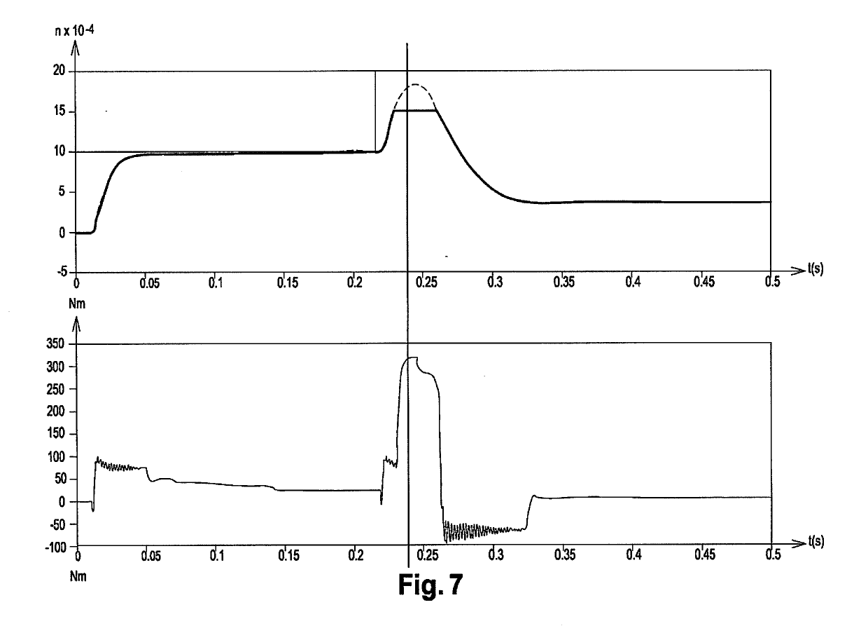

If, however, the position on which the command element is placed is too far (at least 0.2 mm) from the abutment actual position, this leads to the result of FIG. 7. This is particularly the case if the first step has not been carried out. When the motor is cut off, the spring is strongly compressed since the actual abutment position is exceeded. The resisting force on the command element (curve C) rises suddenly. It is essential to know the abutment position with sufficient precision. Indeed, if the spring is excessively compressed, it returns the finger, which does not remain in the abutment position. Conversely, if the position set by the motor is before the abutment actual position, and the compression of the spring is not underway, the command element can still be subjected to other stresses. This is particularly the case in hard impacting zones, which can move the command element, and lose the position thereof.

In conclusion, the invention does not require the installation of any particular device, since it uses information already available at the actuator. Depending on the required level of accuracy, the first step can be sufficient, but the second step provides a finer accuracy, and checks the correct operation of the first step.

The method requires a new determination of the abutment positions, if it is not established by first scans of the travel of the command element. The abutment of the sliding gear on the pinion can be easily identified at the fork position, but much less at the actuator. If dog-coupling is direct, without the teeth being brought into abutment, the mounting clearances mean that the position of the neutral cannot be known with sufficient precision. Indeed, when the fork locks, tooth against tooth, the actuator is still free to move by compressing the assist spring, such that the tooth-against-tooth locking is virtually invisible on the movement of the actuator. As this learning is to be carried out by the actuator module, the latter does not have the fork position measurements. The invention provides a particularly reliable and effective means of identifying the tooth-against-tooth position, sufficiently accurately in order to be able to make sure of the “mechanical neutral” position of the transmission.

1. A learning method for learning a neutral position of a gear shift actuator having a motorized sliding gear between two opposite engaging pinions, and a command element that is position-controlled by a drive motor, which acts on a mechanical assembly for moving the sliding gear provided with a spring which can firstly accumulate energy when teeth of the sliding gear come into abutment against teeth of one of of the pinions to be dog-coupled in order to shift gears and secondly restore the accumulate energy by expansion of the spring in order to assist engagement of the teeth of the sliding gear between the teeth the one of pinions, the learning method comprising:
determining the neutral position of the actuator by estimating a resisting torque on the actuator, during movement of the sliding gear towards the pinions, by scanning abutment positions of the command element and by detecting the abutment positions of the command element when a value of the resisting torque estimated on the actuator crosses a threshold indicating abutment positions of the teeth of the sliding gear against the teeth of each of the two pinions.

2. The learning method as claimed in claim 1, further comprising
of calculating a distance between the abutment positions of the sliding gear, which is repeated if the teeth of the sliding gear engage directly between the teeth of the one of the pinion at the end of travel.

3. The learning method as claimed in claim 2, further comprising
of measuring the abutment positions of the sliding gear by placing the command element in an identified abutment position, then releasing the command element by cutting off the actuating motor to ensure that the command element retains the identified abutment position.

4. The learning method as claimed in claim 1, wherein
the estimation of the resisting torque on the command element is based on an observation of an observed speed of the drive motor and a measured speed using a current measurement of current in the drive motor.

5. The learning method as claimed in claim 4, wherein
the resisting torque is estimated in a controller using a difference between the observed speed and the measured speed.

6. The learning method as claimed in claim 5, wherein
the observed speed is obtained by integrating a term representing a difference between a theoretical torque resulting from the current measurement modified by a torque coefficient, and from a value of an estimation of the resisting torque.

7. The learning method as claimed in claim 1, wherein
the values of the resisting torque on the command element are regularly recorded over the entirety of the travel thereof.

8. The learning method as claimed in claim 7, wherein
the command element is driven by a speed set point.

9. The learning method as claimed in claim 7, wherein
the command element is driven by a ramp position set point.
